(19) United States
(12) Patent Application Publication
(10) Pub. No.: US 2015/0034681 A1
(43) Pub. Date: Feb. 5, 2015

(54) Dispensing Gun

(71) Applicant: Asher Peres, Thornhill (CA)

(72) Inventor: Asher Peres, Thornhill (CA)

(21) Appl. No.: 13/955,655

(22) Filed: Jul. 31, 2013

(51) Int. Cl. B65D 88/54; B67D 7/84

(52) U.S. Cl. CPC B05C 17/00576; B05C 17/0133; B05C 17/00596
USPC 222/326; 222/333; 222/174

(57) ABSTRACT

An improved caulking gun is disclosed. The gun includes a cartridge frame having proximal and distal ends and an extension releasably coupled to the proximal end of the cartridge frame. A telescoping shaft is rotatably mounted with in the extension. A spindle is formed on an end of the telescoping shaft projecting from an end of the extension. A portion of the telescoping shaft is threaded and passes through a threaded sleeve mounted at a distal end of the extension. Rotation of the telescoping shaft causes the telescoping shaft to increase and decrease in length causing the distal portion of the telescoping shaft to move between a retracted position adjacent the proximal end of the cartridge frame and an extended position adjacent the distal end of the cartridge frame. A plunger is releasably mounted to the distal end of the telescoping shaft.

### FIELD OF THE INVENTION

The invention relates generally to devices for dispensing material such as caulking and adhesive from a tube, generally know by the more general terms of dispensing guns and caulking guns.

### BACKGROUND OF THE INVENTION

Caulking guns and dispensing guns are well known in the art and are commonly used for dispensing caulking, adhesives and a variety of other materials from tubes. These tubes generally consist of an elongated tube having a nozzle at one end. The dispensing gun generally has a cartridge housing for holding the tube of material in the correct orientation with the nozzle pointed away from the user. A plunger device is provided with in the dispenser which, when activated, bears against a back end of the tube causing material to be ejected from the nozzle.

Traditionally, dispensing guns used a ratchet operated plunger which was coupled to a spring biased trigger. Repeatedly squeezing the trigger caused the plunger to ratchet forward and drive material through the nozzle. Various improvements have been made to motorize the action of the plunger to make it possible to more quickly and more evenly draw material from the tube. These motorized caulking guns often used a plunger coupled to a threaded rod which, when rotated, caused the plunger to move along the cartridge housing. In some cases, the cartridge housing is coupled to a rotary tool, such as a hand drill, to provide the motive force to drive the dispensing gun. While these motorized dispensing guns can be convenient, they are occasionally susceptible to jamming.

In cases where the caulking, adhesive or other material has to be applied to cracks or crevices which are inconveniently located beyond the user's reach, it is necessary to use an extended caulking or dispensing gun. Ratchet type caulking guns, such as disclosed in U.S. Pat. No. D455,619 to Chang can be made having elongated extensions and elongated ratchet arms. Motorized versions of elongated caulking guns generally use very long threaded rods which are coupled to the rotary tool by a complicated gearing mechanism. The rotary tool causes the relative rotation between the long threaded rod and a threaded sleeve, thereby causing the threaded rod to move back and forth. Other designs such as shown in U.S. Pat. No. 6,041,976 to Robertson provide an elongated extension between the cartridge housing and the rotary tool with a coaxial connection between the rotary tool and the threaded rod. The Robertson device uses an elongated threaded inner shaft contained within an elongated threaded sleeve (outer shaft). Rotating the inner shaft while preventing the outer shaft from rotating causes the outer shaft to telescope (i.e. move axially relative to the inner shaft). The outer shaft in the Robertson device is prevented from rotating together with the inner threaded shaft by means of a member (referred to in the reference as an indicator) projecting from the outer shaft and engaging with a slot formed in the housing. While this system does overcome the complexity of a gearing mechanism, the system is susceptible to jamming due to the long lengths of the threaded rod and the asymmetrical anchoring of the outer shaft by the member (indicator). An improved dispensing device which overcomes the limitations of the prior art, and which is easy and simple to construct, is required.

### SUMMARY OF THE INVENTION

In accordance with one aspect of the present invention, there is provided a dispensing device for dispensing material from a tube of material. The dispensing device includes a cartridge frame for holding the tube of material, the cartridge frame having a proximal end and a distal end. An extension having proximal and distal ends is provided, the distal end of the extension being releasably coupled to the proximal end of the cartridge frame. A telescoping shaft is contained with in the extension, the telescoping shaft having opposite distal and proximal ends, the proximal end of the telescoping shaft being rotatably mounted to the proximal end of the extension, the distal end of the telescoping shaft being rotatably mounted to the distal end of the extension. A spindle is formed on the proximal end of the telescoping shaft projecting from the proximal end of the extension. A distal portion of the telescoping shaft adjacent the distal end of said shaft is threaded with the distal portion of the telescoping shaft threaded through a threaded sleeve mounted at the distal end of the extension such that rotation of the telescoping shaft causes the telescoping shaft to increase and decrease in length causing the distal portion of the telescoping shaft to move between a retracted position adjacent the proximal end of the cartridge frame and an extended position adjacent the distal end of the cartridge frame. A plunger is releasably mounted to the distal end of the telescoping shaft.

In accordance with another aspect of the present invention, there is provided a dispensing tool for dispensing material from a tube of material using a rotary power tool. The dispensing tool includes a cartridge frame for holding the tube of material, the cartridge frame having a proximal end and a distal end and an extension having proximal and distal ends, the distal end of the extension being releasably coupled to the proximal end of the cartridge frame. The dispensing tool also includes a telescoping shaft contained within the extension, the telescoping shaft consisting of an inner shaft coaxially mounted within a tubular outer shaft, the tubular outer shaft having a pair of parallel elongated slots formed along a length of the tubular outer shaft, the outer shaft being coupled to the inner shaft by a pin passing through both slots, the pin fixed to the inner shaft and floating within the slots. A proximal end of the inner shaft is rotatably mounted to the proximal end of the extension, with a spindle fowled on the proximal end of the inner shaft extending through the proximal end of the extension for engagement with the rotary tool. The device further includes a threaded rod having opposite proximal and distal ends, the proximal end of the threaded rod coaxially fixed to the tubular outer shaft, the treaded rod threaded through a threaded sleeve formed on the distal end of the extension with the distal end of the threaded rod projecting into the cartridge frame. Finally, the device also includes a plunger releasably mounted to the distal end of the threaded rod, the plunger movable between the proximal and distal ends of the cartridge frame by rotation of the spindle.

In accordance with yet another aspect of the invention, there is provided a dispensing tool for dispensing material from a tube of material using a rotary power tool, the dispensing tool including a cartridge frame for holding the tube of material and an extension having proximal and distal ends, the distal end of the extension being releasably coupled to a proximal end of the cartridge frame. A telescoping shaft is contained within the extension, the telescoping shaft including an inner shaft coaxially mounted within a tubular outer shaft, the inner and outer shafts coupled together by a linkage, the linkage configured to permit the inner and outer shafts to move axially relative to each other and prevent the inner and outer shafts from rotating relative to each other. A proximal end of the telescoping shaft is rotatably mounted to the proximal end of the extension, a spindle formed on the proximal end of the telescoping shaft extending through the proximal end of the extension for engagement with the rotary tool, rotation of the spindle causing a corresponding rotation of the telescoping shaft. The device further includes a threaded rod having opposite proximal and distal ends, the proximal end of the threaded rod coaxially fixed to a distal end of the telescoping shaft, the treaded rod threaded through a threaded sleeve formed on the distal end of the extension with the distal end of the threaded rod projecting into the cartridge frame. Finally, the device includes a plunger releasably mounted to the distal end of the threaded rod, the plunger movable between the proximal and distal ends of the cartridge frame by rotation of the spindle.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a dispensing gun made in accordance with the present invention showing the plunger in its fully retracted position.

FIG. 2 is a perspective view of the dispensing gun shown in FIG. 1 showing the plunger in its fully extended position.

FIG. 3 is a side view of the proximal end of the extension portion of the invention.

FIG. 4 is a side view of the distal end of the extension portion of the invention.

FIG. 5 is a perspective view partly in cross section of the linkage between the inner and outer shafts of the telescoping shaft portion of the present invention.

In the drawings like characters of reference indicate corresponding parts in the different figures.

### DETAILED DESCRIPTION OF THE INVENTION

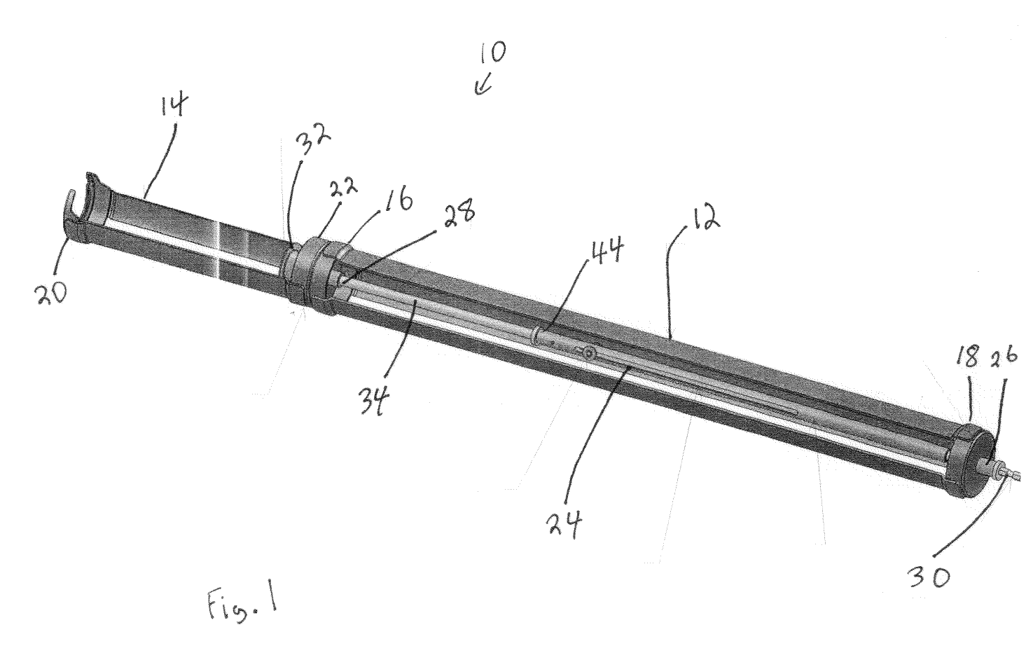

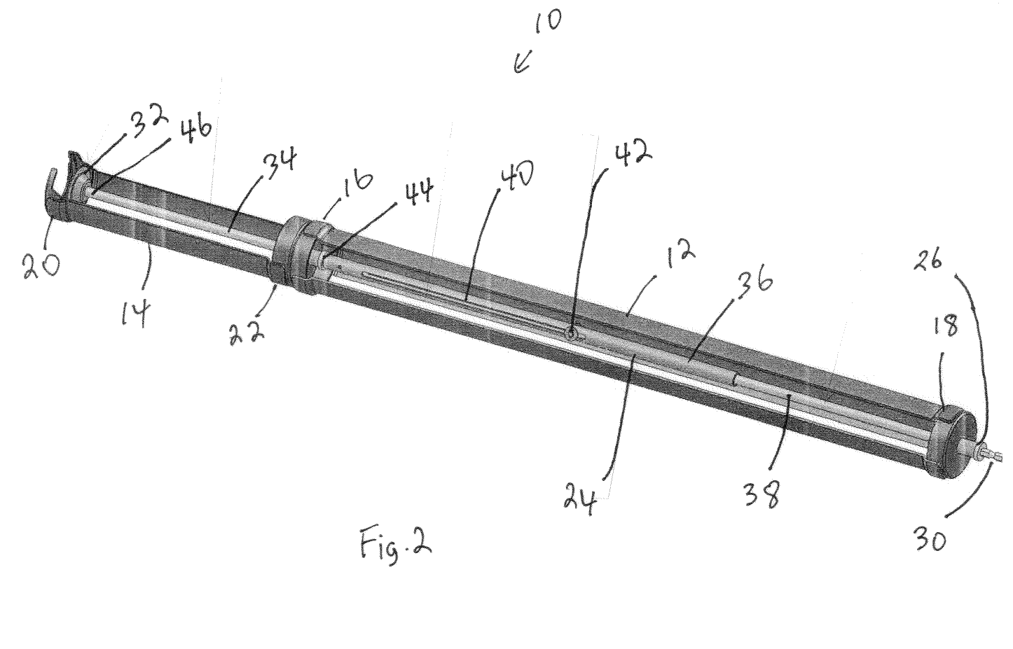

Referring to FIGS. 1 and 2, a dispensing gun (or caulking gun) made in accordance with the present invention, shown generally as item 10, includes a cartridge housing 14 having opposite proximal and distal ends 22 and 20, respectively. Cartridge housing 14 is dimensioned and configured to hold a standard tube of caulking or adhesive (not shown) with the nozzle portion of the caulking tube (not shown) positioned at distal end 20. Cartridge housing 14 is coaxially mounted to extension 12 which has opposite distal and proximal ends 16 and 18, respectively. A quick connect coupling may be formed on proximal end 22 and distal end 16 to enable a user to quickly connect cartridge housing 14 to extension 12.

Coaxially mounted within extension 12 is telescoping shaft 24 which has opposite proximal and distal ends 26 and 28, respectively. Distal end 28 of telescoping shaft 24 protrudes through distal end 16 of extension 12 and proximal end 22 of cartridge housing 14 to project into the cartridge housing. Plunger 32 is releasably mounted to distal end 28. Plunger 32 is dimensioned to bear against a tube of caulking (not shown) to expel the contents of the tube when the plunger is moved towards distal end 20 of the cartridge housing.

Proximal end 26 of shaft 24 protrudes through proximal end 18 of extension 12 and forms a spindle 30 which is dimensioned and configured to be attachable to a rotary tool (not shown). In particular, spindle 30 preferably comprises a hexagonal member which is chuckable and easily mounted to the chuck (not shown) of any commonly available electric or portable hand drill (not shown). Telescoping shaft 24 is rotationally mounted within extension 12 such that rotation of spindle 30 causes the shaft to rotate along its entire length. As best seen in FIG. 2, shaft 24 consists of an inner shaft 38 coaxially contained within a tubular outer shaft 36. Inner shaft 38 and outer shaft 36 are coupled together by a linkage which permits the inner and outer shaft to telescope (i.e. move axially relative to each other) while preventing the inner and outer shaft from rotating relative to each other. The linkage consists of an elongated slot 40 formed along outer shaft 36 and a link pin 42 which floats within slot 40 and is fixed to inner shaft 38. In effect, link pin 42 and slot 40 permits the outer shaft 36 to slide back and forth (or telescope) along inner shaft 38 but at the same time forces shafts 36 and 38 to rotate together.

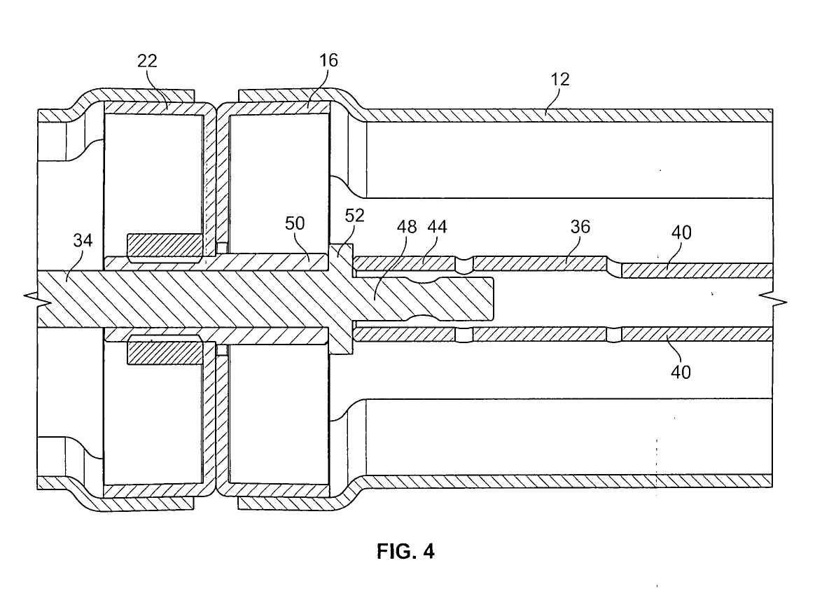

Threaded rod 34 is coaxially fixed to distal end 44 of outer shaft 36 and moves in unison with the outer shaft. As best seen in FIG. 4, threaded rod 34 has a proximal end 48 which is fixed to distal end 44 of shaft 36 by means known generally in the aft. Threaded rod 34 is threaded through correspondingly threaded sleeve 50. It will be appreciated that as shaft 36 rotates, threaded rod 34 will rotate causing the threaded rod to be translated axially through sleeve 50. Stop 52 is formed on threaded rod 34 to stop the movement of the threaded rod into sleeve 50 just before the end of the threaded rod.

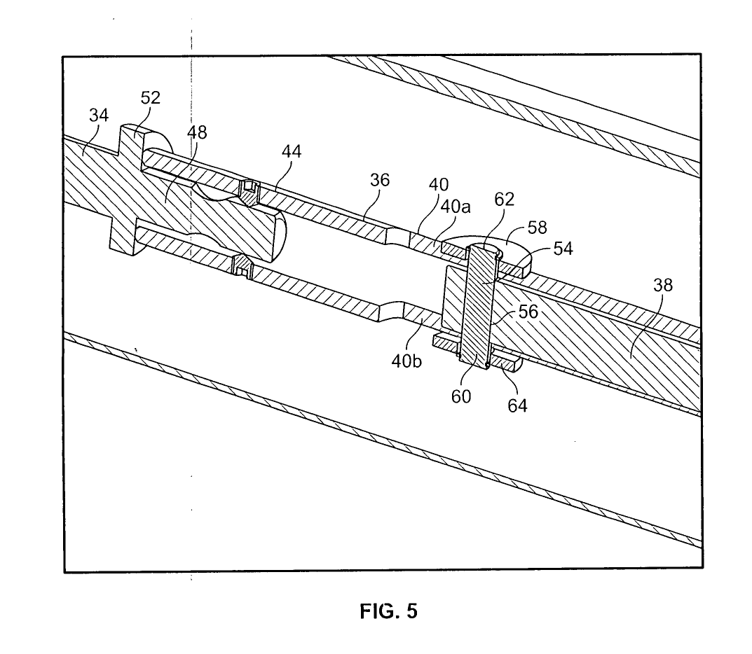

Referring now to FIG. 5, tubular shaft 36 has an elongated slot 40 which extends partway along the length of shaft 36. Slot 40 extends through shaft 36 to form a pair of slots 40a and 40b. Link pin 54 is fixed in inner shaft 38 and passes through aperture 56 formed in shaft 38. Opposite ends 60 and 62 of link pin 54 are dimensioned to float within slots 40b and 40a, respectively. Washers 58 and 64 are mounted to the ends of the link pin to secure the link pin in slot 40. Slot 40 and link pin 54 create a sliding linkage between inner shaft 38 and outer shaft 36, thereby permitting the entire telescoping shaft to vary in length while ensuring that the component parts are rotationally locked together so that they rotate as one. Furthermore, the sliding linkage between the inner and outer shafts is symmetrical because slots 40a and 40b are formed on opposite sides of outer shaft 36. This ensures the efficient transmission of torque from one end of the telescoping shaft to the other, permitting smooth operation and decreasing the likelihood of jamming.

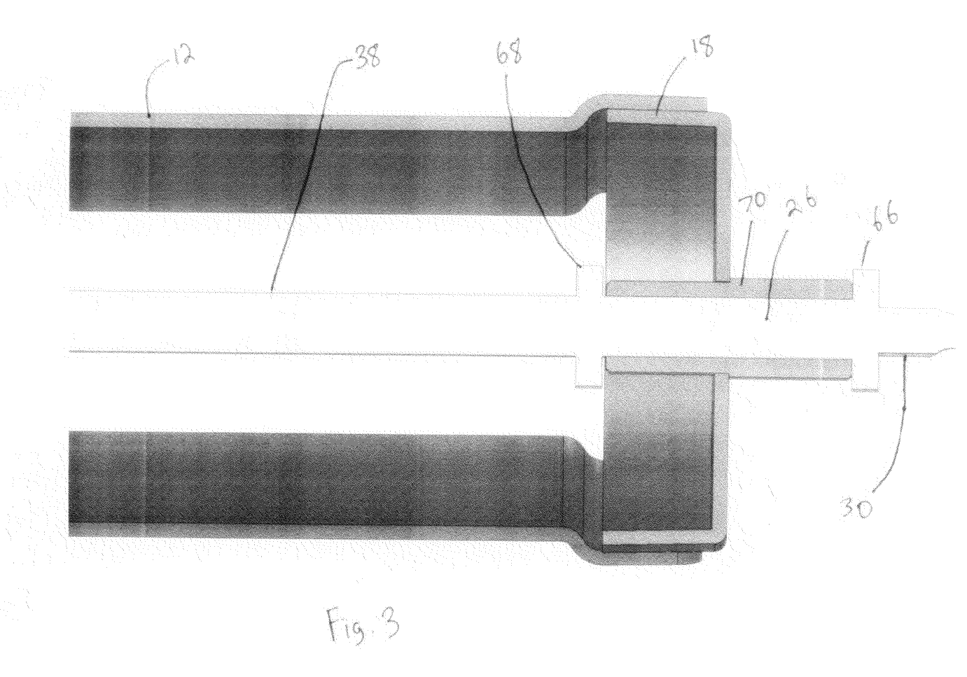

Referring now to FIG. 3, end 18 of extension 12 is provided with a sleeve 70 through which proximal end 26 of inner shaft 38 passes. Sleeve 70 forms a rotational mounting point allowing the end of shaft 38 to freely rotate. Spindle 30 is formed on the end of shaft 38. Stops 68 and 66 are formed on shaft 38 to prevent the end of the shaft from slipping out of sleeve 70.

Referring back to FIGS. 1 and 2, to operate the device, cartridge housing 14 is first coaxially mounted to end 16 of extension 12. Plunger 32 is then attached to end 46 of telescoping shaft 24. If need be, shaft 24 is rotated in order to place plunger 32 in a retracted position adjacent end 22 of cartridge housing 14 as seen in FIG. 1. A tube of caulking (not shown) is then inserted into cartridge housing 14. The user can then attach a rotary tool such as a portable hand drill (not shown) to spindle 30. The user can then grasp extension 12 to position the dispensing gun as required. A handle (not shown) may be formed on extension 12 to help the user grasp the extension. The user then engages the rotary tool to cause telescoping shaft 24 to rotate rapidly. As shaft 24 rotates rapidly, threaded rod 34 is drawn into cartridge housing 14, causing plunger 32 to move towards its extended position as shown in FIG. 2. The plunger moving towards its extended position causes caulking (or similar material) to be ejected from the tube of material contained in cartridge housing 14.

The advantages of the present invention over the prior art are numerous. Firstly, the use of a telescoping shaft coaxially aligned with the cartridge housing and the rotary tool eliminates the need for complicated gearing mechanisms. Also, the use of a sliding linkage between the inner and outer shafts in the telescoping shaft permits torque from the rotary tool to be efficiently transferred to the cartridge housing without the likelihood of jamming. This permits the extension to be made very long.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A dispensing gun for dispensing material from a tube of material, the dispensing gun comprising:
a. a cartridge frame for holding the tube of caulk, the cartridge frame having a proximal end and a distal end;
b. an extension having proximal and distal ends, the distal end of the extension being releasably coupled to the proximal end of the cartridge frame;
c. a telescoping shaft contained in the extension, the telescoping shaft having opposite distal and proximal ends, the proximal end of the telescoping shaft being rotatably mounted to the proximal end of the extension, the distal end of the telescoping shaft being rotatably mounted to the distal end of the extension, a spindle formed on the proximal end of the telescoping shaft projecting from the proximal end of the extension;
d. a distal portion of the telescoping shaft adjacent the distal end of said shaft being threaded, the distal portion of the telescoping shaft threaded through a threaded joint at the distal end of the extension such that rotation of the telescoping shaft causes the telescoping shaft to increase and decrease in length causing the distal portion of the telescoping shaft to move between a retracted position adjacent the proximal end of the cartridge frame and an extended position adjacent the distal end of the cartridge frame,
e. a plunger releasably mounted to the distal end of the telescoping shaft.

2. The dispensing gun defined in claim 1 wherein the telescoping shaft comprises first and second shaft segments mounted together by a linkage, the linkage permitting the first and second shaft segments to axially move relative to each other in a telescoping fashion while preventing the first and second shaft segments from rotating relative to each other.

3. The dispensing gun defined in claim 2 wherein the telescoping shaft comprises an inner shaft contained within an outer shaft, the outer shaft comprising an elongated tube dimensioned to receive the inner shaft.

4. The dispensing gun defined in claim 3 wherein the floating link comprises an elongated groove formed in one of the inner and outer shafts, a link pin coupling the inner shaft to the outer shaft, the link pin floating within the elongated groove.

5. The dispensing gun defined in claim 4 wherein a pair of parallel elongated grooves are formed on the outer shaft, the link pin passing through the parallel elongated grooves, the link pin coupled to the inner shaft.

6. The dispensing gun defined in claim 5 wherein the distal portion of the telescoping shaft comprises a threaded rod coupled to a distal end of the outer shaft.

7. A dispensing tool for dispensing material from a tube of material using a rotary power tool, the dispensing tool comprising:
a. a cartridge frame for holding the tube of material, the cartridge frame having a proximal end and a distal end;
b. an extension having proximal and distal ends, the distal end of the extension being releasably coupled to the proximal end of the cartridge frame;
c. a telescoping shaft contained within the extension, the telescoping shaft comprising an inner shaft coaxially mounted within a tubular outer shaft, the tubular outer shaft having a pair of parallel elongated slots formed along a length of the tubular outer shaft, the outer shaft being coupled to the inner shaft by a pin passing through both slots, the pin fixed to the inner shaft and floating within the slots;
d. a proximal end of the inner shaft being rotatably mounted to the proximal end of the extension, a spindle formed on the proximal end of the inner shaft extending through the proximal end of the extension for engagement with the rotary tool;
e. a threaded rod having opposite proximal and distal ends, the proximal end of the threaded rod coaxially fixed to the tubular outer shaft, the treaded rod threaded through a threaded sleeve formed on the distal end of the extension with the distal end of the threaded rod projecting into the cartridge frame;
f. a plunger releasably mounted to the distal end of the threaded rod, the plunger movable between the proximal and distal ends of the cartridge frame by rotation of the spindle.

8. A dispensing tool for dispensing material from a tube of material using a rotary power tool, the dispensing tool comprising:
a. a cartridge frame for holding the tube of material, the cartridge frame having a proximal end and a distal end;
b. an extension having proximal and distal ends, the distal end of the extension being releasably coupled to the proximal end of the cartridge frame;
c. a telescoping shaft contained within the extension, the telescoping shaft comprising an inner shaft coaxially mounted within a tubular outer shaft, the inner and outer shafts coupled together by a linkage, the linkage configured to permit the inner and outer shafts to move axially relative to each other and prevent the inner and outer shafts from rotating relative to each other;
d. a proximal end of the telescoping shaft being rotatably mounted to the proximal end of the extension, a spindle funned on the proximal end of the telescoping shaft extending through the proximal end of the extension for engagement with the rotary tool, rotation of the spindle causing a corresponding rotation of the telescoping shaft;
e. a threaded rod having opposite proximal and distal ends, the proximal end of the threaded rod coaxially fixed to a distal end of the telescoping shaft, the threaded rod threaded through a threaded sleeve formed on the distal end of the extension with the distal end of the threaded rod projecting into the cartridge frame;
f. a plunger releasably mounted to the distal end of the threaded rod, the plunger movable between the proximal and distal ends of the cartridge frame by rotation of the spindle.

9. The dispensing tool as defined in claim 8 wherein the linkage comprises an elongated slot formed along one of the inner and outer shafts and a pin fixed to the other of the inner and outer shafts, the pin positioned to float within the elongated slot.

10. The dispensing tool as defined in claim 9 wherein a pair of opposed elongated slots are formed along the outer shaft, the pin fixed to the inner shaft, the pin having opposite ends floating in the elongated slots.

11. The dispensing tool as defined in claim 10 wherein the spindle is formed on a proximate end of the inner shaft and the threaded rod is fixed to a distal end of the outer shaft.
